(19) United States
(12) Patent Application Publication
(10) Pub. No.: US 2007/0019831 A1
(43) Pub. Date: Jan. 25, 2007

(54) Array speaker system

(75) Inventor: Akira Usui, Hamamatsu-shi (JP)

Correspondence Address: ROSSI, KIMMS & McDOWELL LLP., P.O. BOX 826, ASHBURN, VA, 20146-0826, US

(73) Assignee: Yamaha Corporation, Shizuoka-ken (JP)

(21) Appl. No.: 10/558,542

(22) PCT Filed: Jun. 1, 2004
(86) PCT No.: PCT/JP04/07911

§ 371 Date: Nov. 29, 2005

(30) Foreign Application Priority Data
Jun. 2, 2003 (JP) 2003-156766

(51) Int. Cl. H04R 5/02

(52) U.S. Cl. 381/300

(57) ABSTRACT

In an array speaker system that performs multi-channel reproduction using an array speaker constituted by arraying a plurality of speaker units in a matrix manner, a left channel signal, a right channel signal, and a center channel signal, all of which instruct reproduction of sound at a front side of a listener, are subjected to weighting using weight coefficients based on a Bessel function so as to drive the speaker units, thus realizing spherical sound emission characteristics. In addition, a surround left channel signal and a surround right channel signal, both of which instruct reproduction of sound at a rear side of the listener, are subjected to beam processing, whereby sound is reflected on a sound reflection position such as a wall surface or a ceiling and is then emitted in the form of a sound beam reaching the rear side of the listener.

### TECHNICAL FIELD

This invention relates to array speaker systems in which a plurality of speaker units are arranged in an array.

### BACKGROUND ART

Conventionally, array speaker systems in which a plurality of speakers are regularly arranged so as to reproduce sounds are known. In these array speaker systems, as a form of trouble due to the use of plural speakers, there occurs a phenomenon in which as reproduced audio frequencies become higher, so-called beam-like concentration of sound and comb-like distribution of sound (in which sound is spread in a comb-shape manner) emerge in sound emission characteristics, which vary in response to frequencies and which make it difficult to realize hearing of prescribed tone pitches outside of a sound emission center position, or in which audio frequency characteristics greatly vary in response to listening positions.

FIGS. 9A and 9B are three-dimensional graphs showing simulation results regarding sound emission characteristics when fifteen speaker units are linearly arrayed and are each driven to emit sound with the same weight (i.e., weight coefficient “1”). Herein, FIG. 9A shows sound emission characteristics upon emission of a signal of an audio frequency of 1 kHz in a horizontal cross-sectional plane, a vertical cross-sectional plane, and a projection plane, which is 2 m distant from the front surface of the speaker system. FIG. 9B shows sound emission characteristics upon emission of a signal of an audio frequency of 10 kHz. They show that sound pressure becomes higher in white areas.

As shown in FIGS. 9A and 9B, beam-like concentration of sound occurs in sound emission characteristics in the vertical cross-sectional plane, wherein as the audio frequency becomes higher, the comb-like distribution of sound apparently occurs. Such sound is not preferable in terms of the sense of hearing; in addition, it is impossible to hear sounds of specific audio frequencies outside of the position in which the beam-like concentration of sound occurs; and this causes a problem in that the listening position is extremely limited. Incidentally, sectorial sound emission characteristics occur in the horizontal cross-sectional plane.

In order to avoid the occurrence of the aforementioned phenomenon, a so-called Bessel array method, in which a string of regularly arranged speakers are driven with weights using a string of coefficients based on a first-order Bessel function so as to realize spherical sound emission characteristics, is known. In this method, a plurality of speaker units, which are linearly arranged with prescribed distances therebetween, are driven to emit sound signals, which are weighted by use of weight coefficients based on the first-order Bessel function represented by the following equation.

$${J}_{n} ( x ) = {( \frac{x}{2} )}^{n} {\sum }_{k = 0}^{∞} \frac{{( - 1 )}^{k} {( x / 2 )}^{2 k}}{k ! Γ ( n + k + 1 )}$$

Similarly to FIGS. 9A and 9B, FIGS. 10A and 10B show simulation results regarding sound emission characteristics of a Bessel array in which fifteen speaker units are linearly and vertically arranged and are driven by use of signals, which are weighted based on the first-order Bessel function. Herein, FIG. 10A shows sound emission characteristics upon emission of a signal of an audio frequency of 1 kHz in a horizontal cross-sectional plane, a vertical cross-sectional plane, and a projection plane, which is 2 m distant from the front surface of the speaker system. FIG. 10B shows sound emission characteristics upon emission of a signal of an audio frequency of 10 kHz.

Incidentally, J₋₇(x) to J₇(x) are used as weight coefficients adapted to speaker units, wherein when x=3.0, coefficients C1 to C15, which are used for multiplication with respect to signals driving fifteen speaker units, are calculated as follows:
C1=J₋₇(3)=−0.0025
C2=J₋₆(3)=0.0114
C3=J₋₅(3)=−0.0430
C4=J₋₄(3)=0.1320
C5=J₋₃(3)=−0.3091
C6=J₋₂(3)=0.4861
C7=J₋₁(3)=−0.3391
C8=J₀(3)=−0.2601
C9=J₁(3)=0.3391
C10=J₂(3)=0.4861
C11=J₃(3)=0.3091
C12=J₄(3)=0.1320
C13=J₅(3)=0.0430
C14=J₆(3)=0.0114
C15=J₇(3)=0.0025

It is obvious that through the comparison between FIGS. 9A and 9B and FIGS. 10A and 10B, in the case of the Bessel array, no beam-like concentration of sound or comb-like distribution of sound occurs in the sound emission characteristics, thus realizing substantially spherical characteristics. As described above, by driving speaker units with weights corresponding to weight coefficients, it is possible to effectively avoid the occurrence of beam-like concentration of sound and comb-like distribution of sound in sound emission characteristics.

Japanese Examined Patent Application Publication No. H01-25480 discloses a speaker system adopting a simplified form of the aforementioned Bessel array.

When sound emitted from an array speaker is reflected on a wall surface and a ceiling so as to realize surround effect, characteristics of the array speaker in which emitted sound is easily subjected to beam-like concentration may work desirably. However, there is a problem in that the listening position is limited with respect to a tone-generation channel regarding sound emission in front of the listener.

It is an object of this invention to provide an array speaker system in which by effectively using characteristics of an array speaker, in which beam-like concentration of sound easily occurs, and the properties of a Bessel array, which realize spherical sound emission characteristics, both of the front-side sound and rear-side sound produced by the array speaker can be reproduced desirably.

### DISCLOSURE OF THE INVENTION

An array speaker system of this invention is constituted by arraying a plurality of speaker units, each of which inputs a front-side channel signal for instructing generation of sound reproduced at a front side of a listener and a rear-side channel signal for instruction generation of sound reproduced at a rear side of the listener. Herein, speaker units are each driven by use of a front-side channel signal that is weighted using weight coefficients based on a Bessel function; and the speaker units are each driven by use of a rear-side channel signal that is subjected to prescribed delay processing so as to form a sound beam, which is reflected on a wall surface and a ceiling and then reaches the rear side of the listener.

The aforementioned array speaker system can be constituted by use of a first array speaker, which is arranged at the left side of a display, and a second array speaker, which is arranged at the right side of the display, for example.

With respect to the first array speaker arranged at the left side of the display, a left-channel signal and a center-channel signal are weighted using weight coefficients based on a Bessel function; and a surround left-channel signal is subjected to beam processing. With respect to the second array speaker arranged at the right side of the display, a right-channel signal and a center-channel signal are weighted using weight coefficients based on a Bessel function; and a surround right-channel signal is subjected to beam processing.

When the array speaker system is constituted by use of an array speaker arranged at the front side of a listener, front-side channel signals, i.e., a center-channel signal, a left-channel signal, and a right-channel signal, are respectively weighted using weight coefficients based on a Bessel function; and rear-side channel signals, i.e., a surround left-channel signal and a surround right-channel signal, are subjected to beam processing.

Furthermore, when the array speaker system is constituted by use of array speakers that are arranged in a matrix manner, speaker units are driven by use of signals, which instruct reproduction of sounds at setup locations of the array speakers and which are respectively weighted using weight coefficients based on a Bessel function. In addition, speaker units are driven by use of signals, which instruct reproduction of sounds at specific positions outside of setup locations of array speakers and which are subjected to delay processing so as to form sound beams reaching the specific positions.

### BRIEF DESCRIPTION OF THE DRAWINGS

FIG. 1 is a front view showing the exterior appearance of an array speaker system in accordance with a first embodiment of this invention;

FIG. 2 diagrammatically shows a sound field realized by multi-channel reproduction in the array speaker system shown in FIG. 1;

FIG. 3 is a circuit diagram showing the constitution of a drive circuit for driving a plurality of speaker units constituting the array speaker;

FIG. 4 show examples of weight coefficients, which are used for the weighting based on a Bessel function and which are respectively applied to input signals of the speaker units constituting the array speaker;

FIG. 5 is an illustration for explaining a setup method of a delay value applied to a surround channel signal;

FIG. 6 is a front view showing the exterior appearance of an array speaker system in accordance with a second embodiment of this invention;

FIG. 7 is a circuit diagram showing a drive circuit for driving a plurality of speaker units included in the array speaker system shown in FIG. 6;

FIG. 8 is an illustration for explaining an array speaker system in accordance with a third embodiment of this invention;

FIG. 9A shows sound emission characteristics of an array speaker with respect to an audio frequency of 1 kHz;

FIG. 9B shows sound emission characteristics of an array speaker with respect to an audio frequency of 10 kHz;

FIG. 10A shows sound emission characteristics of a Bessel array with respect to an audio frequency of 1 kHz; and

FIG. 10B shows sound emission characteristics of a Bessel array with respect to an audio frequency of 10 kHz.

### BEST MODE FOR CARRYING OUT THE INVENTION

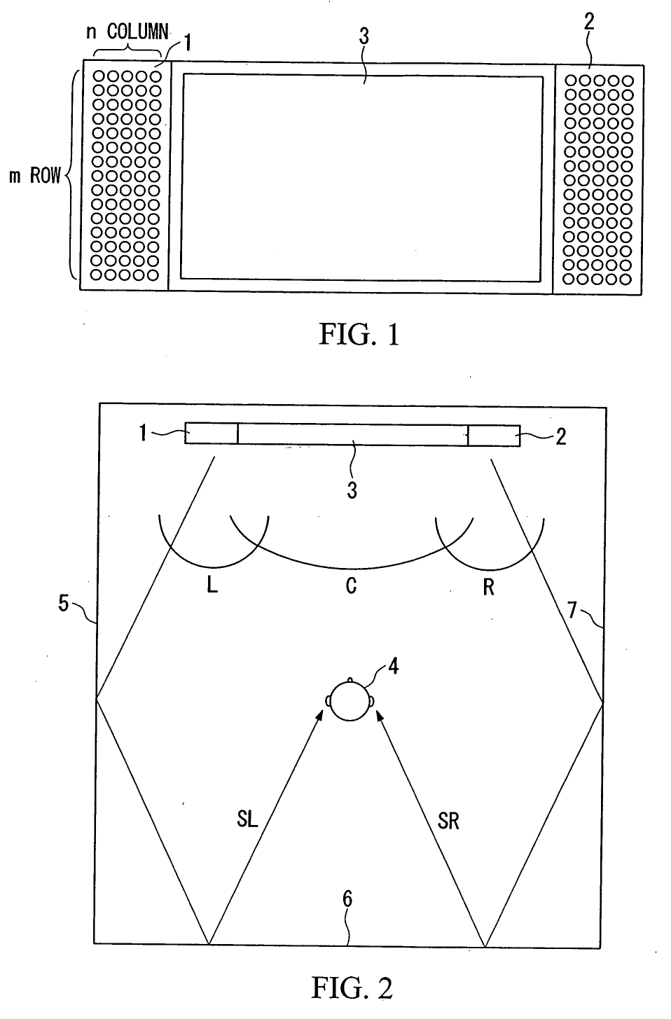

FIG. 1 shows the exterior appearance of an array speaker system in accordance with a first embodiment of this invention. Reference numerals 1 and 2 designate array speakers, each of which has m×n speaker units arrayed in m rows and n columns (where m and n are integers of 2 or more); and reference numeral 3 designates a display having a screen or a large-size display screen. Herein, m is set to an integer of 6 or more, and n is set to an integer of 5 or more, whereby each of the array speakers 1 and 2 is preferably formed in a vertically elongated shape. That is, in the present embodiment, the first array speaker 1 and the second array speaker 2, each of which has a vertically elongated shape, are arranged at the left side and the right side of the display 3; thus, it is possible to realize a superior design.

FIG. 2 diagrammatically shows a sound field realizing multi-channel reproduction using the array speaker system of the first embodiment shown in FIG. 1. It performs 5.1 channel reproduction, for example. FIG. 2 is an illustration of a listening room in a plan view, wherein reference numeral 4 designates a listener; reference numeral 5 designates a left-side wall surface; reference numeral 6 designates a rear-side wall surface; and reference numeral 7 designates a right-side wall surface.

As shown in FIG. 2, in the first embodiment of this invention, reproduction for a main left channel (L), a center channel (C), and a surround left channel (SL) is allocated to the first array speaker 1 arranged at the left side of the display 3; and reproduction for a main right channel (R), a center channel (C), and a surround main right channel (R) is allocated to the second array speaker 2 arranged at the right side of the display 3.

A Bessel array method in which the array speakers 1 and 2 are each driven with weights corresponding to weight coefficients based on a Bessel function is applied to the three channels lying in front of the listener 4, i.e., the aforementioned channels C, L, and R, whereby it is possible to realize spherical sound emission characteristics as shown in FIG. 2.

With respect to the SL channel and the SR channel for the rear side of the listener 4, sound beams emitted from the array speakers 1 and 2 respectively are reflected on prescribed walls and ceiling so as to make it possible for the listener 4 to hear sound virtually emitted from the rear side. That is, the sound beam of the SR channel emitted from the first array speaker 1 is firstly directed to the left-side wall surface 5; then, it is reflected on the wall surface 5; next, it is reflected on the ceiling (not shown); furthermore, it is reflected on the rear-side wall surface 6; thereafter, it reaches the rear-left portion of the head of the listener 4. The sound beam of the SR channel emitted from the second array speaker 2 is firstly directed to the right-side wall surface 7; then, it is reflected on the wall surface 7, ceiling, and wall surface 6 in turn; thereafter, it reaches the rear-right portion of the head of the listener 4.

As described above, in the present embodiment, it is possible to realize spherical sound emission characteristics with respect to the three channels in front of the listener 4, i.e., the channels L, R, and C; hence, it is possible to realize natural audio reproduction without causing limitation to listening position. In addition, components of sound beams are effectively used with respect to the surround channels SL and SR regarding the rear side of the listener 4; hence, it is possible to realize audio reproduction at the rear side of the listener 4.

Next, a circuit constitution for driving the array speakers 1 and 2 will be described.

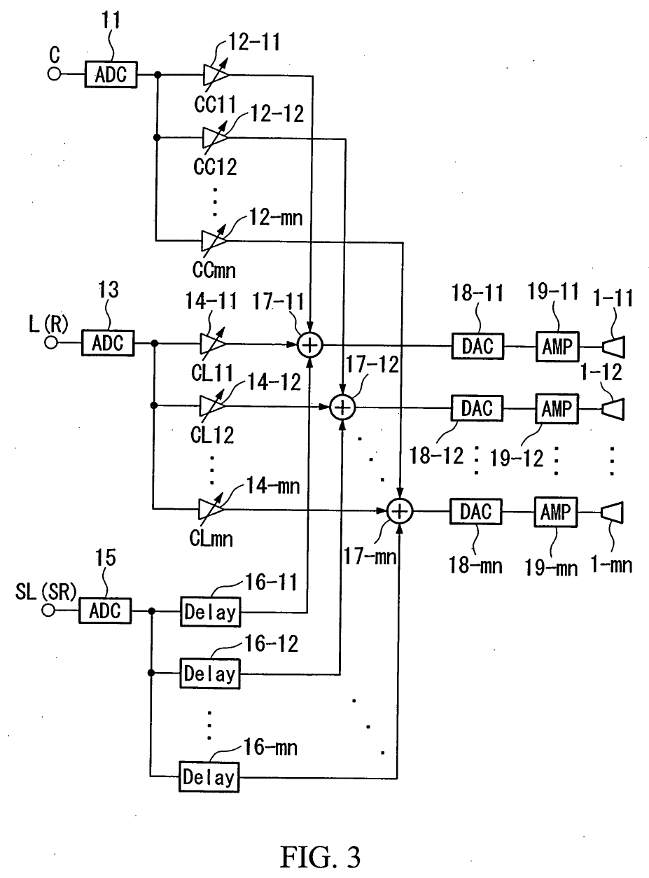

In FIG. 3, reference numerals 1-11 to 1-mn designate speaker units of m×n array forming the first array speaker 1; and reference numeral 11 designates an A/D converter (ADC) for converting signals of the center channel (C) into digital data. Reference numerals 12-1 to 12-mn designate weighting means that are respectively arranged for the speaker units 1-11 to 1-mn so as to impart weights using weight coefficients CC11 to CCmn based on a Bessel function to the center-channel signals. Reference numeral 13 designates an A/D converter (ADC) for converting signals of the main left channel (L) into digital data. Reference numerals 14-11 to 14-mn designate weighting means that are respectively arranged for the speaker units 1-11 to 1-mn so as to impart weights using weight coefficients CL11 to CLmn based on a Bessel function to the L-channel signals. Reference numeral 15 designates an A/D converter (ADC) for converting signals of the surround left channel (SL) into digital data. Reference numerals 16-11 to 16-mn designate delay means that are respectively arranged for the speaker units 1-11 to 1-mn so as to apply the corresponding delay values to the LS-channel signals, thus realizing beam-like concentration of sound in the surround left channel direction.

Reference numerals 17-11 to 17-mn designate adders that are respectively arranged for the speaker units 1-11 to 1-mn so as to add output signals of the weighting means 12-11 to 12-mn, output signals of the weighting means 14-11 to 14-mn, and output signals of the delay means 16-11 to 16-mn together. Output signals of the adders 17-11 to 17-mn are converted into analog signals in D/A converters (DAC) 18-11 to 18-mn; furthermore, they are amplified in power amplifiers 19-11 to 19-mn; thereafter, they are supplied to the speaker units 1-11 to 1-mn respectively.

As described above, addition signals that are produced by adding the C channel signals and L channel signals weighted based on the Bessel function to the SL channel signals applied with prescribed delay values are supplied to the speaker units 1-11 to 1-mn constituting the first array speaker 1 as its drive signals.

Illustration is not provided herein, but it is possible to provide amplifiers for adjusting gains of the signals of the respective channels with respect to the speaker units. That is, it is possible to additionally provide amplifiers for adjusting gains of the signals for the speaker units prior to the weighting means 12-11 to 12-mn, prior to the weighting means 14-11 to 14-mn, or prior to the delay means 16-11 to 16-mn.

In addition, the same circuit constitution as the circuit constitution of FIG. 3 arranged for the first array speaker 1 is arranged for the second array speaker 2. That is, the circuit constitution of FIG. 3 can be modified as shown in the reference symbols in parentheses so as to realize the circuit constitution for the second array speaker 2, wherein the L channel is replaced with the R channel, and the SL channel is replaced with the SR channel.

In the circuit constitution of FIG. 3, signals of respective channels are converted into digital data in the A/D converters (ADC) 11, 13, and 15; then, the digital data are subjected to weighting and delay processing; thereafter, they are added together, but it is possible to perform signal processing in an analog manner without performing digitization. That is, analog signals can be directly subjected to weighting, delaying, and adding, whereby it is possible to omit the A/D converters (ADC) 11, 13, and 15 as well as the D/A converter (DAC) 18. Alternatively, it is possible to use digital amplifiers for the replacement of the amplifiers (AMP) 19 by omitting only the D/A converter (DAC) 18.

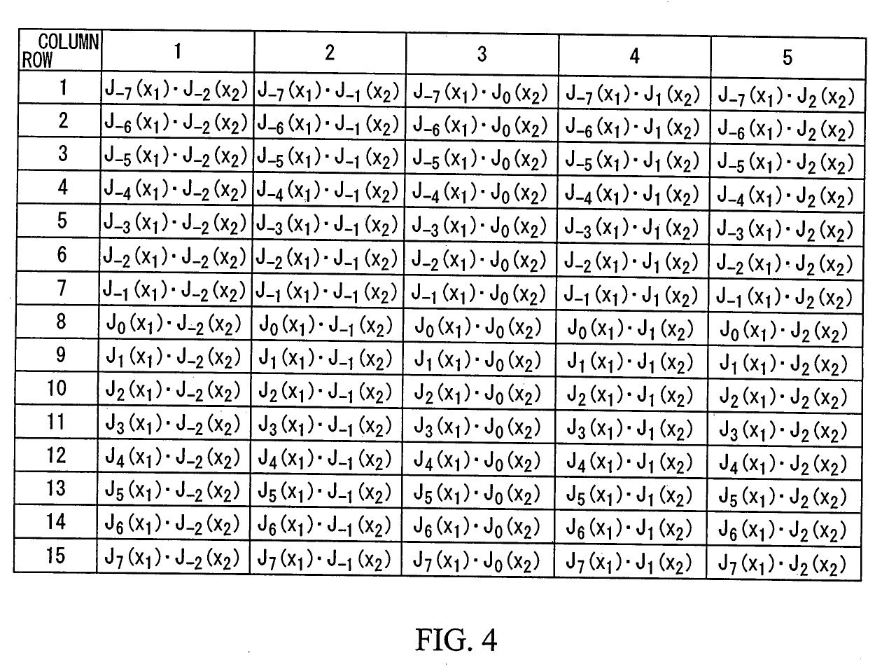

FIG. 4 shows examples of weight coefficients based on a Bessel function, which are applied to the weighting means 12-11 to 12-mn and the weighing means 14-11 to 14-mn respectively.

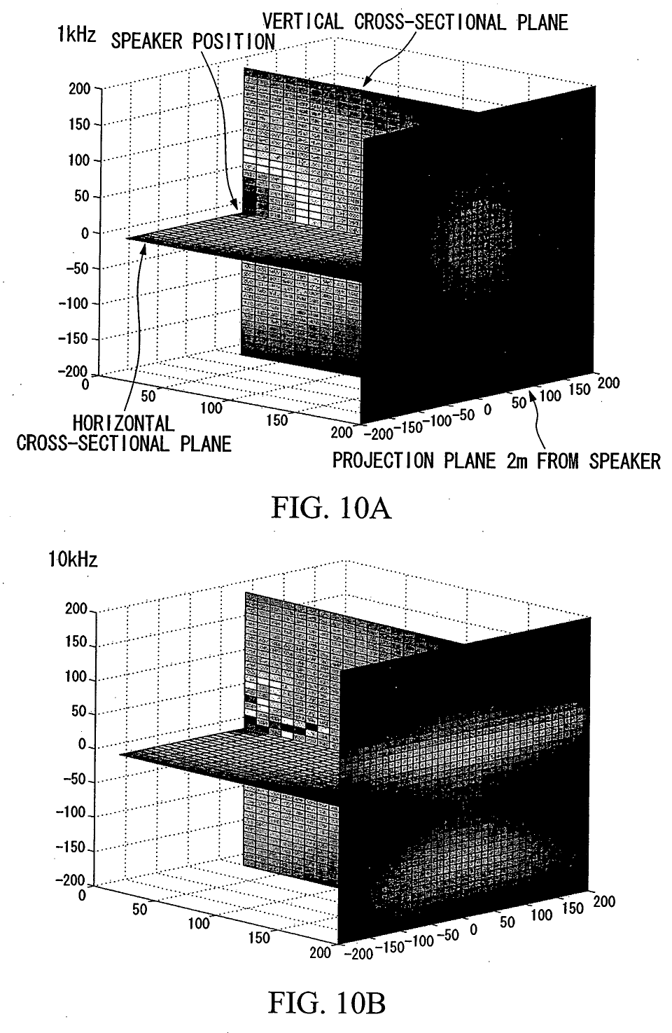

It is described in conjunction with FIGS. 10A and 10B that when weights based on a Bessel function are applied to speaker units that are linearly arrayed in an array speaker, sound emission characteristics in the vertical cross-sectional plane have a spherical shape (or a circular shape). In the present embodiment in which the array speaker is constituted using the speaker units 1-11 to 1-mn arrayed in m rows and n columns, weights based on a Bessel function are applied in both the row direction and column direction, thus realizing spherical sound emission characteristics.

FIG. 4 shows examples of weight coefficients respectively applied to m×n speaker units 1-11 to 1-mn where m=15, n=5. Herein, weight coefficients of J₋₇(x1), J₋₆(x1), J₋₄(x1), J₋₃(x1), J₋₂(x1), J₋₂(x1), J₀(x1), J₁(x1), J₁(x1), J₃(x1), J₄(x1), J₅(x1), J₆(x1), and J₇(x1) are used for fifteen speaker units vertically aligned; and weight coefficients J₋₂(x2), J₋₁(x2), J₀(x2), J₁(x2), and J₂(x2) are used for five speaker units horizontally aligned. That is, weights corresponding to products of the vertical-alignment weight coefficients Jₖ(x1) (where k=−7, −6, −5, −4, −3, −2, −1, 0, 1, 2, 3, 4, 5, 6, 7) and the horizontal-alignment weight coefficients J₁(x2) (where k=−2, −1, 0, 1, 2) are applied to speaker units 1-ij (where i=1 to m, j=1 to n). Thus, it is possible to realize spherical sound emission characteristics.

It is possible to use the same weight coefficient for both the L-channel signal and the C-channel signal; alternatively, it is possible to use different weight coefficients using different parameters x1 and x2. In addition, it is possible to use weight coefficients, which are similarly determined, with respect to the second array speaker 2.

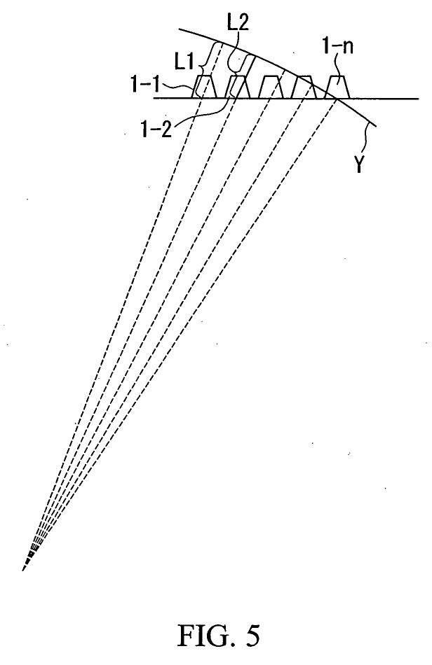

Delay values applied to the delay means 16-11 to 16-mn with respect to signals of the surround left channel (SL) will be described with reference to FIG. 5.

In FIG. 5, reference numerals 1-1 to 1-n designate n speaker units that are arrayed in a single line. In order to realize a sound beam (i.e., a concentrated flow of acoustic waves) focusing on a prescribed position X with respect to a string of speaker units, a circle Y is drawn about the focal point X to pass a far-most speaker unit (i.e., a speaker unit 1-n); then, with respect to intersecting points at which line segments connecting between the focal point X and the speaker units 1-1 to 1-n intersect the circle Y, distances Li (where i=1, 2, . . . , n) from the speaker units are each divided by the speed of sound, thus producing delay times with respect to the speaker units respectively. This makes it possible for sounds emitted from the speaker units 1-1 to 1-n to reach the focal point X with the same phase, wherein the focal point X serves as a virtual sound source. Suppose that an angle of the sound beam reaching the focal point X is identical to an angle of the sound beam reaching the left-side wall surface 5 in FIG. 2; and the distance for the focal point X is identical to the distance for the setup position of the surround left channel (SL) speaker in FIG. 2. In this case, the listener hears the sound as if the sound of the SL channel were emitted from the SL-channel speaker positioned at the focal point X. With respect to the surround right channel (SR), the second array speaker 2 arranged at the right side is controlled to emit a sound beam as described above.

An example in which a plurality of speaker units 1-1 to 1-n are arrayed in a one-dimension manner is described in conjunction with FIG. 5, but the aforementioned array speakers 1 and 2 are arranged in a two-dimensional manner. Therefore, the circle Y is replaced with a sphere drawn about the focal point X; hence, delay times, which are produced by dividing distances between the speaker units and the spherical surface by the speed of sound, are applied to the speaker units.

In order for a sound beam emitted from the array speaker 1 or 2 to reach the wall surface 5 or 7 with a prescribed angle, it is preferable to set the number n of the speaker units in the columnar alignment to 5 or more.

As described above, in the present embodiment, sound beams emitted from the array speakers are reflected on the wall surfaces and ceiling so as to realize the surround channel sound that is transmitted to the listener at the rear side. That is, it is possible to effectively use characteristics of the array speaker in which sound is transformed into a beam.

The first embodiment describes the array speaker system constituted by the first array speaker arranged at the left side of the display 3 and the second array speaker 2 arranged at the right side of the display 3. This invention is not necessarily limited to an array speaker system having a divided arrangement of speakers.

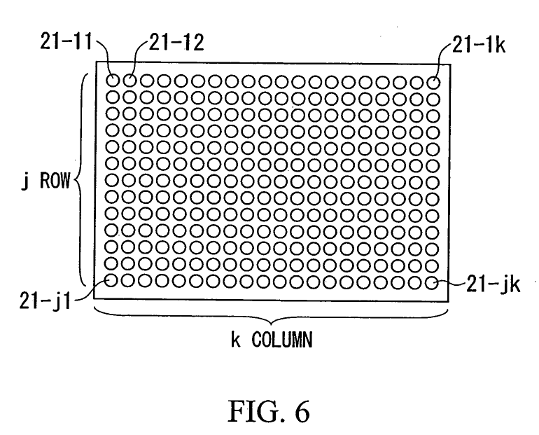

FIG. 6 shows the exterior appearance of an array speaker system in accordance with a second embodiment of this invention.

In FIG. 6, the array speaker system of the second embodiment is constituted by a plurality of speaker units 21-11 to 21-jk, which are arrayed in j rows and k columns. Herein, it is preferable that j and k be set to integers of five or more.

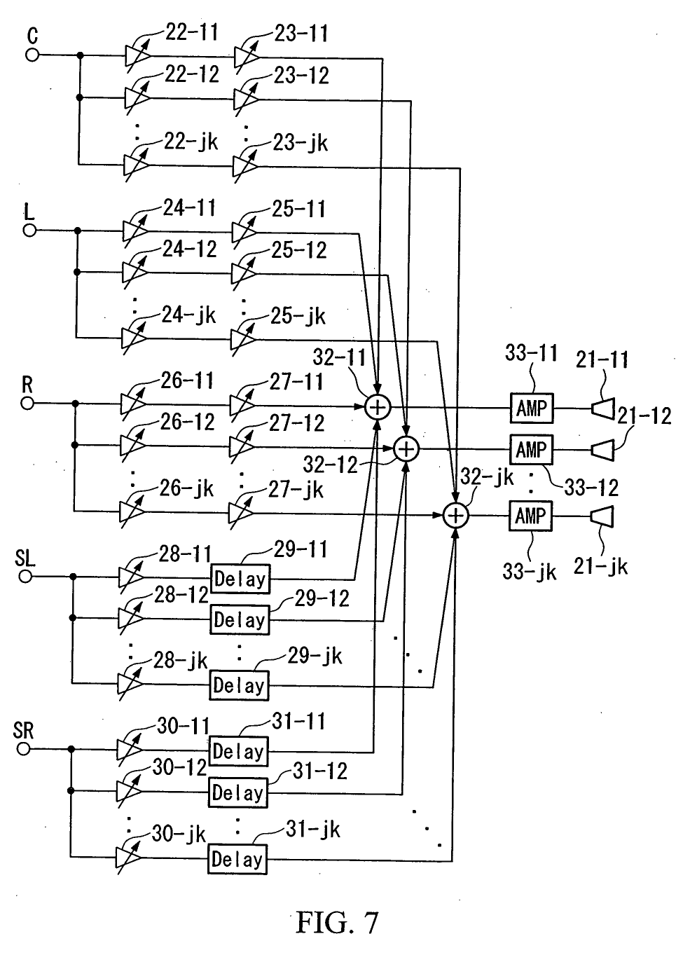

FIG. 7 is a circuit diagram showing the constitution of a drive circuit for driving the array speaker system of the second embodiment shown in FIG. 6.

In FIG. 7, reference numerals 22-11 to 22-jk designate multipliers that are respectively provided in connection with the speaker units 21-11 to 21-jk so as to apply prescribed gains to signals of the aforementioned center channel (C). Reference numerals 23-11 to 23-jk designate weighting means for applying weight coefficients based on a Bessel function to the C-channel signals.

Reference numerals 24-11 to 24-jk designate multipliers that are provided in connection with the speaker units 21-11 to 21-jk respectively so as to apply prescribed gains to the L-channel signals. In addition, reference numerals 25-11 to 25-jk designate weighting means for applying weight coefficients based on a Bessel function to the L-channel signals.

Reference numerals 26-11 to 26-jk designate multipliers that are provided in connection with the speaker units 21-11 to 21-jk respectively so as to apply prescribed gains to the R-channel signals. In addition, reference numerals 27-11 to 27-jk designate weighting means for applying weight coefficients based on a Bessel function to the R-channel signals.

Reference numerals 28-11 to 28-jk designate multipliers that are provided in connection with the speaker units 21-11 to 21-jk respectively so as to apply prescribed gains to the SL-channel signals. In addition, reference numerals 29-11 to 29-jk designate delay means that apply prescribed delay values to the speaker units 21-11 to 21-jk in order to form a sound beam in response to the SL-channel signals.

Reference numerals 30-11 to 30-jk designate multipliers that are provided in connection with the speaker units 21-11 to 21-jk respectively so as to apply prescribed gains to the SR-channel signals. In addition, reference numerals 31-11 to 31-jk designate delay means that apply prescribed delay values to the speaker units 21-11 to 21-jk in order to form a sound beam in response to the SR-channel signals.

Reference numerals 32-11 to 32-jk designate adders that add together output signals of the weighing means 23-11 to 23-jk regarding the C-channel signals, output signals of the weighting means 25-11 to 25-jk regarding the L-channel signals, output signals of the weighting means 27-11 to 27-jk regarding the R-channel signals, output signals of the delay means 29-11 to 29-jk regarding the SL-channel signals, and output signals of the delay means 31-11 to 31-jk regarding the SR-channel signals. Reference numerals 33-11 to 33-jk designate amplifiers that respectively amplify output signals of the adders 32-11 to 32-jk so as to supply them to the speaker units 21-11 to 21-jk.

In the array speaker system of the second embodiment having the aforementioned constitution, three-channel signals in front of the listener, i.e., C-channel signals, L-channel signals, and R-channel signals, are respectively weighted using weight coefficients based on a Bessel function, whereby the speaker units 21-11 to 21-jk emit sounds in a Bessel-array-like manner. In addition, with respect to surround signals at the rear side of the listener, i.e., SL-channel signals and SR-channel signals, the speaker units 21-11 to 21-jk emit desired sound beams.

In addition, the multipliers 22-11 to 22-jk, 24-11 to 24-jk, 26-11 to 26-jk, 28-11 to 28-jk, and 30-11 to 30-jk are provided to set up gains for the speaker units 21-11 to 21-jk with respect to signals of the C channel, L channel, R channel, SL channel, and SR channel. Herein, the multipliers 24-11 to 24-jk, which are provided to apply gains to the speaker units 21-11 to 21-jk with respect to the L-channel signals, increase gains for the speaker units arrayed at the left-half side but decrease gains for the speaker units arrayed at the right-half side within the speaker units arrayed in a two-dimensional manner, for example. In addition, the multipliers 26-11 to 26-jk, which are provided to apply gains to the speaker units 21-11 to 21 -jk with respect to the R-channel signals, increase gains for the speaker units arrayed at the right-half side but decrease gains for the speaker units arrayed at the left-half side within the speaker units arrayed in a two-dimensional manner, for example.

In the second embodiment compared with the first embodiment shown in FIG. 1, it is possible to increase the number of speaker units arrayed in a column direction; hence, it is possible to reliably and adequately perform beam control in a horizontal direction; thus, it is possible to reproduce sounds of rear-side surround channels with good fidelity.

Incidentally, the aforementioned description is made with respect to the 5.1 channel surround system, which is an example of multi-channel reproduction; however, this invention is not necessarily so limited to and is similarly applicable to other multi-channel reproduction using 7.1 channels, for example.

Applied fields of this invention are not necessarily limited to multi-channel reproduction; hence, it is possible to perform audio reproduction using a Bessel array at the setup position of an array speaker and to perform audio reproduction using sound beams at another position.

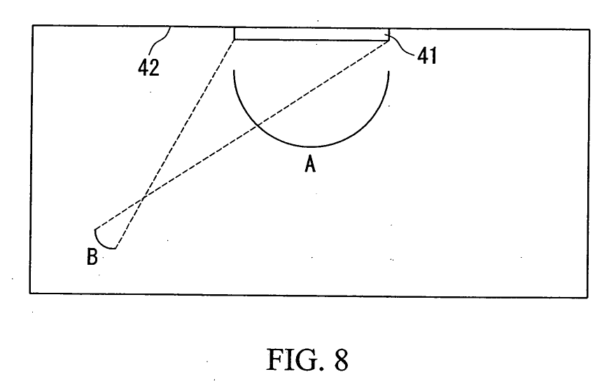

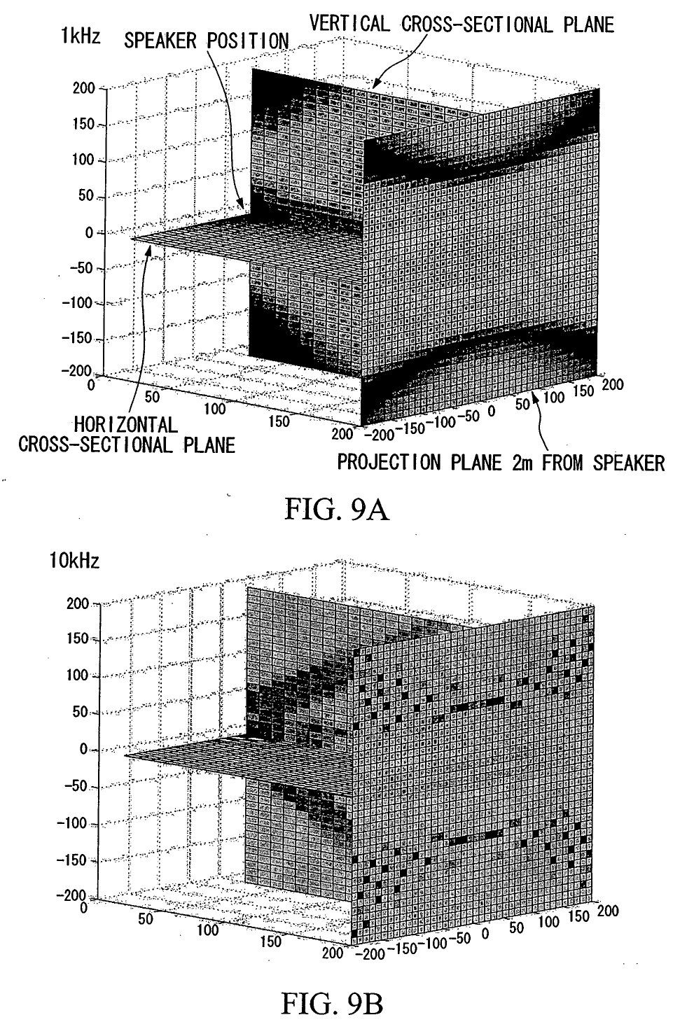

Next, a third embodiment in which this invention is applied to an audio reproduction system other than one effecting multi-channel reproduction will be described with reference to FIG. 8.

In FIG. 8, reference numeral 41 designates an array speaker that is constituted similarly to in the foregoing embodiments; and reference numeral 42 designates a ceiling to which the array speaker 41 is fixed.

In the third embodiment, speaker units are driven by use of signals, which are weighted based on a Bessel function, at a position A entirely covering the whole space of a room in which the array speaker 41 is fixed to the ceiling 42. In addition, sound beams are emitted to focus on a certain position such as a comer B of the room other than the setup position of the array speaker 41 by use of delayed signals. Thus, by use of the array speaker 41, it is possible to emit prescribed sound throughout the entirety of the room; and it is possible to emit sound beams towards a specific position such as the comer B of the room, for example. In this case, it is possible to emit reproduced sounds towards the positions A and B by use of the same signal; alternatively, it is possible to emit sounds reproduced by use of different signals.

As described heretofore, the array speaker system of this invention has a variety of effects and technical features as follows:
(1) With respect to front-side channels of the array speaker, a Bessel array is used to reproduce natural and spherical sound waves. With respect to rear-side channels, sound beams are reflected on the wall surfaces and ceiling so as to reproduce desired sound at the rear side of the listener.
(2) A Bessel array is used to reproduce sound at the setup position of the array speaker; and sound beams are reproduced with respect to another position. Hence, natural and spherical sound waves can be reproduced at the position of the array speaker; and desired sound can be localized at a desired position.

Incidentally, this invention is not necessarily limited to the aforementioned embodiments; hence, this invention embraces all changes within the scope of the invention as defined in the appended claims.

1. An array speaker system constituted by arraying a plurality of speaker units, said array speaker system comprising:
a means for inputting front-side channel signals for instructing reproduction of sound at a front side of a listener and rear-side channel signals for instructing reproduction of sound at a rear side of the listener;
a means for driving the speaker units with weights using weight coefficients based on a Bessel function with respect to the front-side channel signals; and
a means for driving the speaker units with respect to the rear-side channel signals in such a way that sound is reflected at at least one sound reflection position such as a wall surface or a ceiling and is then applied with a prescribed delay value so as to form a sound beam reaching the rear-side of the listener.

2. An array speaker system according to claim 1, which is constituted by a first array speaker arranged at a left side of a display and a second array speaker arranged at a right side of the display.

3. An array speaker system according to claim 2, wherein the front-side channel signals are formed using a left channel signal, a right channel signal, and a center channel signal, and the rear-side channel signals are formed using a surround left channel signal and a surround right channel signal,
and wherein in the first array speaker arranged at the left side of the display, the left channel signal and the center channel signal are subjected to weighting using the weight coefficients based on the Bessel function, and the surround left channel signal is subjected to sound beam processing,
and wherein in the second array speaker arranged at the right side of the display, the right channel signal and the center channel signal are subjected to weighting using the weight coefficients based on the Bessel function, and the surround right channel signal is subjected to sound beam processing.

4. An array speaker system according to claim 1, wherein a single array speaker is arranged in front of the listener, and wherein in the array speaker, a left channel signal, a right channel signal, and a center channel signal, all of which form the front-side channel signals, are subjected to weighting using the weight coefficients based on the Bessel function, and a surround left channel signal and a surround right channel signal, both of which form the rear-side channel signals, are subjected to sound beam processing.

5. An array speaker system including an array speaker in which a plurality of speaker units are arrayed in a matrix manner,
wherein a first audio signal for instructing reproduction of sound at a setup position of the array speaker is subjected to weighting using a weight coefficient based on a Bessel function so as to drive the speaker units,
and wherein a second audio signal for instructing reproduction of sound at a specific position other than the setup position of the array speaker is subjected to delay processing so as to drive the speaker units in such a way that a sound beam reaching the specific position is formed.
